(19) United States
(12) Patent Application Publication
(10) Pub. No.: US 2006/0215656 A1
(43) Pub. Date: Sep. 28, 2006

(54) Method, device and program storage medium for controlling communication

(76) Inventor: Tetsuya Shirogane, Kanagawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/138,504

(22) Filed: May 27, 2005

(30) Foreign Application Priority Data
Mar. 23, 2005 (JP) 2005-083167

(51) Int. Cl. H04L 12/56

(52) U.S. Cl. 370/389

(57) ABSTRACT

Disclosed is a communication control method which enables a single device to be connected appropriately to multiple hosts under various conditions. The method, which is executed by a storage system composed of a processing unit, a storage unit and a connecting unit for a network, includes the steps of receiving a request for a communication from the network by the connecting unit, determining at least one characteristic of the communication by the processing unit, storing the determined characteristic and a threshold of the characteristic in the storage unit, conducting an analysis of the characteristic by the processing unit, while referring to the threshold, specifying at least one parameter of a communication protocol based on a result of the analysis by the processing unit, and performing the communication in accordance with the specified parameter by the connecting unit.

### CROSS-REFERENCE TO RELATED APPLICATIONS

This application claims the benefit of Japanese Patent Application 2005-083167 filed on Mar. 23, 2005, the disclosure of which is incorporated herein by reference.

### BACKGROUND OF THE INVENTION

1. Field of the Invention

The present invention relates to a method and a device for controlling communications upon access to storages. Furthermore, the present invention relates to a medium that stores a program for executing the above method.

2. Description of the Related Art

Conventionally, communications between a server (or host) and a storage device have been performed in accordance with Fibre Channel (FC), and the server and the storage have mainly been connected through a specific network. Such a network is called “storage area network (SAN)”. Especially, SAN that employs FC as a network control protocol is called “FC-SAN”. In FC-SAN, a small computer system interface (SCSI) or a single byte command code set (SBCCS) is used as an FC upper protocol for controlling storages.

Lately, TCP/IP used in a network technique has been utilized, instead of FC. An upper protocol of TCP/IP, which uses SCSI commands, is Internet SCSI (iSCSI). These TCP/IP and iSCSI are standardized by Internet Engineering Task Force (IETF). TCP/IP is defined by both a transmission control protocol (TCP) and an internet protocol (IP). Generally, communications (or protocols) are controlled for each layer, and protocol layers handling TCP and IP are represented by TCP and IP layers, respectively. The IP layer performs communications per packet, but does not have a function of ensuring the communications. Hence, a TCP layer is responsible for this function instead.

The above function includes following steps of:
(1) detecting errors of send data;
(2) checking whether or not data is received successfully by receiving ACK (packets for confirming reception of data), and
(3) retransmitting data unless ACK is received within a predetermined period.

SAN employing IP is called “IP-SAN”. IP has been applied to typical networks used widely in homes or offices, such as a local area network (LAN). Devices according to IP, such as network switches, interface cards or cables, are available at lower cost than those according to FC. Therefore, IP-SAN can be constructed at low cost. In addition, IP-SAN can be connected to an existing network, thereby setting up communications between a server and a storage without using a dedicated network. Accordingly, IP-SAN is connected to a wide area network (WAN) or the Internet, so that long distance communications are realized. However, compared to communications according to FC, communications of IP are more likely to cause packet losses during communications. Therefore, in order to ensure that data is sent/received, packets of TCP layer are necessary to be re-sent. This may deteriorate the input/output performance of IP-SAN greatly. A communication system of IP is often constructed by multiple devices. In this case, RTT which is a period lasted from sending of packets to receiving of ACK is prone to extend. To give an example, if communications are done through a LAN, its RTT is as short as about 1 ms, but with the Internet, its RTT may be more than 100 ms.

Referring to FIG. 25, a function of a device in compliance with iSCSI is split into five layers composed of a SCSI layer 3000, iSCSI layer 3010, TCP layer 3020, IP layer 3030 and MAC layer 3040. The MAC layer, which is called “media access control layer”, is typically used for Ethernet (trademark) or Gigabit Ethernet (trademark). The lengths of data handled by the respective protocol layers are different from one another, and different headers are added to data in the respective layers.

The layers carry out processes forming a SCSI CDB (command descriptor block) 3100, an iSCSI PDU (protocol data unit) 3110, TCP packets 3120, IP packets 3130, and MAC frames (or Ethernet frames upon handling Ethernet) 3140, respectively. The SCSI CDB 3100 has the form of a read or write command, a response to a received command, date being read, or data to be written.

When a certain device tries to send the SCSI CDB 3100, iSCSI layer 3010 receives the SCSI CDB 3100 from the SCSI layer 3000, handles it as an ISCSI data segment 3114, adds an iSCSI header 3112 to the ISCSI data segment 3114, and passes it to the TCP layer 3020 in the format of the ISCSI PDU 3110. Following this, the TCP layer 3020 splits the iSCSI PDU 3110 into multiple TCP segments 3124, adds TCP headers 3122 to the segments 3124, and passes them to the IP layer 3030 in the format of the TCP packets 3120. A split scheme in the TCP layer 3020 will be described later. Subsequently, the IP layer 3030 receives the TCP packets 3120 from the TCP layer, handles them as pieces of IP data 3134, adds IP headers 3132 to the pieces of data, and passes them to the MAC layer 3040 in the format of the IP packets 3130. Next, the MAC layer 3040 receives the IP packets 3130 from the IP layer 3030, handles them as pieces of frame data 3144, and adds MAC headers 3142 and MAC trailers 3146 to the pieces of data 3144 to thereby form MAC frames 3140. Finally, the MAC frames 3140 are sent to a communication partner.

On the other hand, when a device receives the MAC frames 3140, the above steps are carried out in the reverse order.

Communications according to iSCSI are established between a host (initiator) and a storage (target), by forming “connection”. The group of the connections is called “session”. The concepts of the connection and the session are handled in the TCP and iSCSI layers.

Typically, the maximum segment size (MSS) of each TCP packet 3120 depends on that of the MAC frame 3140 in the MAC layer 3040. In Gigabit Ethernet, assuming that the maximum transmission unit (MTU) of the Ether frame is 1500 bytes, and the size of both IP the header 3132 and the TCP header 3122 is 20 bytes. In this case, the MSS of the TCP packet 3120 is 1460 bytes (1500 bytes−20 bytes−20 bytes=1460 bytes). In this condition, when data of 4096 bytes is sent in response to a read or write command of the SCSI layer, the corresponding iSCSI PDU 3110 is 4144 bytes in size. This is because the iSCSI header 3112 of 48 bytes is added to the data 3100 of 4096 bytes. Subsequently, the iSCSI PDU 3110 is split into three TCP segments of 1460, 1460 and 1224 bytes.

In each protocol layer, as the size of data handled at the same time is larger, the overhead of a protocol is lower. In other words, since the ratio of header to actual data is smaller, the bandwidth is- fully used, and the total number of times that the headers are added is decreased, thereby enhancing the efficiency of the header process.

However, the losses or RTT of packets may be increased on the IP network. In this case, decrease in the size of data to be handled at the same time can lead to better communication performance. For example, as for iSCSI PDU, a receiver cannot start a protocol process until receiving all of the TCP packets making up the iSCSI PDU. If this receiver receives the TCP packets on the network in which frequent packet losses and long RTT occur, then the time period during which all the TCP packets are received ends up being long. As a result, the start of the protocol process delays. Excessively long delay may be regarded as abnormal (any error has occured). For example, in the SCSI layer, unless a response is received within a predetermined period since sending of a command, a receiver regards the current communication as abnormal, and followed by, starts a timeout process. Moreover, in the iSCSI layer, a device sends iSCSI PDU called “NOP” to a communication partner at regular intervals and, then receives a response to the NOP, thus monitoring the presence of the partner. The time interval of sending of the NOP is defined by a value called “keep alive timer”.

The error rate and RTT of a network depend on static or dynamic communication status, such as the configuration or traffic of the network. In view of this communication status, the individual protocol layers need to be set adequately. Setting factors mean the length of data to be handled at the same time, the capacity of the buffer allocated to the sending process, sending interval, and optional control functions. These factors depend on various network parameters or optional algorithms (or protocol options). Herein, the network parameters or the protocol options are denoted by “network setting”.

Conditions required for systems of IP-SAN, such as servers or storages, are complex, compared to those of FC-SAN. These conditions depend on not only the factors of the protocol layer but also various communication factors. For example, as for a server, its performance and network topology need to be considered. Factors determining the performance include the clock frequency of a CPU, the capacity of a memory, and the capacity of internal data bus. If the performance of a server is low, then the performance of the communications is not enhanced at all, even when a high-spec storage is used. The performance of communications is represented by I/O per second (IOPS), throughput (MB/S) or the like.

iSCSI storage technique has originally been adopted to replace FC storage technique, and has been implemented by dedicated networks different from other general-purpose networks. The iSCSI storage technique has developed, while being applied to the combination of dedicated networks and LANs, and wide area networks (WANs) such as the Internet. In the future, it is expected that the application of the iSCSI storage technique will further expand. However, at present, the iSCSI storage technique does not sufficiently allow for optimization of communications when a large number of hosts or a wide variety of networks are used.

Japanese Unexamined Patent Application Publication 8-186601 discloses a network technique intended for realizing optimized data transfer in accordance with the type of data or the status of a communication partner. Specifically, when a connection is established between a device and a communication partner, the device queries the partner about its connection parameters for controlling transfer conditions. Then, the device sets its own connection parameters, based on the parameters sent from the partner. Finally, the device communicates with the partner through a network. Moreover, Japanese Unexamined Patent Application Publication 2004-297351 discloses another network technique. Specifically, a plurality of logical channels on a single physical port are used according to each communication priority from a terminal.

However, neither of the above techniques allow for the case where a device communicates with multiple partners of different communication statuses at the same time. In other words, these techniques do not support to optimize a communication per session.

In IP networks, communication qualities and RTT are varied per session. Therefore, the appropriate network setting for an IP network may differ per session, and their conditions may be changed dynamically. This becomes a problem.

Furthermore, IP storage systems may have a relatively small number of ports. This is because IP storage systems are required to be configured at lower cost than FC storage systems. In this case, multiple sessions may be handled at a single port simultaneously. This becomes an additional problem.

Taking the above disadvantage into account, the present invention has been conceived. An object of the present invention is to provide a communication control method and a communication control device in IP storage technique, which both enable a single device to be connected appropriately to multiple hosts under various conditions such as communication distance or quality. An additional object of the present invention is to provide a medium that stores a program for executing the above method.

### SUMMARY OF THE INVENTION

According to an aspect of the present invention, there is provided, a communication control method executed by a storage system which includes a processing unit, a storage unit and a connecting unit for a network, the method including:
(a1) receiving a request for a communication from the network by the connecting unit;
(b1) determining at least one characteristic of the communication by the processing unit;
(c1) storing the determined characteristic and a threshold of the characteristic in the storage unit;
(d1) conducting an analysis of the characteristic by the processing unit, while referring to the threshold;
(e1) specifying at least one parameter of a communication protocol based on a result of the analysis by the processing unit; and
(f1) performing the communication in accordance with the specified parameter by the connecting unit.

According to another aspect of the present invention, there is provided, a storage system including a processing unit, a storage unit and a connecting unit for a network, the storage system including functions of:
(a2) receiving a request for a communication from the network by the connecting unit;
(b2) determining at least one characteristic of the communication by the processing unit;
(c2) storing the determined characteristic and a threshold of the characteristic in the storage unit;
(d2) conducting an analysis of the characteristic by the processing unit, while referring to the threshold;
(e2) specifying at least one parameter of a communication protocol based on a result of the analysis by the processing unit; and
(f2) performing the communication in accordance with the specified parameter by the connecting unit.

According to still another aspect of the present invention, there is provided, a storage medium storing a program that executes the above-described method.

With the above method, device and program storage medium, a single device can be connected appropriately to multiple hosts under various conditions such as communication distance or quality.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a block diagram illustrating hardware of an electronic computer system 1 (1A) according to a first embodiment of the present invention;

FIG. 2 is a block diagram illustrating a module configuration of the electronic computer system 1 (1A);

FIG. 3 is a view depicting an example of a session-unit network setting table of the first embodiment;

FIG. 4 is a view depicting an example of a session-unit network information table of the first embodiment;

FIG. 5 is a flowchart showing a receiving process of lower layers, according to the first embodiment;

FIG. 6 is a flowchart showing a receiving process of upper layers, according to the first embodiment;

FIG. 7 is a flowchart showing an iSCSI control PDU process of the receiving process;

FIG. 8 is a flowchart showing an iSCSI log-in request PDU process of the receiving process;

FIG. 9 is a flowchart showing a sending process according to the first embodiment;

FIG. 10 is a flowchart showing a timer interrupt process in the SCSI layer, according to the first embodiment;

FIG. 11 is a flowchart showing a timer interrupt process, according to the first embodiment;

FIG. 12 is a flowchart showing a timer interrupt process for changing the contents of the session-unit network setting table, according to the first embodiment;

FIG. 13 is a block diagram illustrating the flow of accessing/updating to or of the session-unit network setting table;

FIG. 14 is a block diagram illustrating a module configuration of an electronic computer system 1 (1B) according to a second embodiment of the present invention;

FIG. 15 is a view depicting an example of a group-unit network setting table of the second embodiment;

FIG. 16 is a view depicting an example of a session-unit network information table of the second embodiment;

FIG. 17 is a flowchart showing a timer interrupt process for updating the session-unit network information table;

FIG. 18 is a block diagram illustrating a module configuration of an electronic computer system 1 (1C) according to a third embodiment of the present invention;

FIG. 19 is a view depicting an example of a port-unit network setting table according to the third embodiment;

FIG. 20 is a view depicting an example of a session-unit network information table according to the third embodiment;

FIG. 21 is a flowchart showing a timer interrupt process for updating the session-unit network setting table.

FIG. 22 is a view depicting a series of operations in an update process for an iSNS name server;

FIG. 23 is a view for explaining an example of the step of changing the contents registered in the iSNS name server according to the third embodiment;

FIG. 24 is a view for explaining a negotiation in a network setting upon log-in of a storage system according to a fourth embodiment of the present invention; and

FIG. 25 is a view for explaining the relation between protocol layers and sending/receiving data in a communication device in accordance with the iSCSI.

### DETAILED DESCRIPTION OF THE EXEMPLARY EMBODIMENTS OF THE INVENTION

### First Embodiment

In a first embodiment of the present invention, at least one network port through which a communication is controlled per session is provided.

[System Configuration]

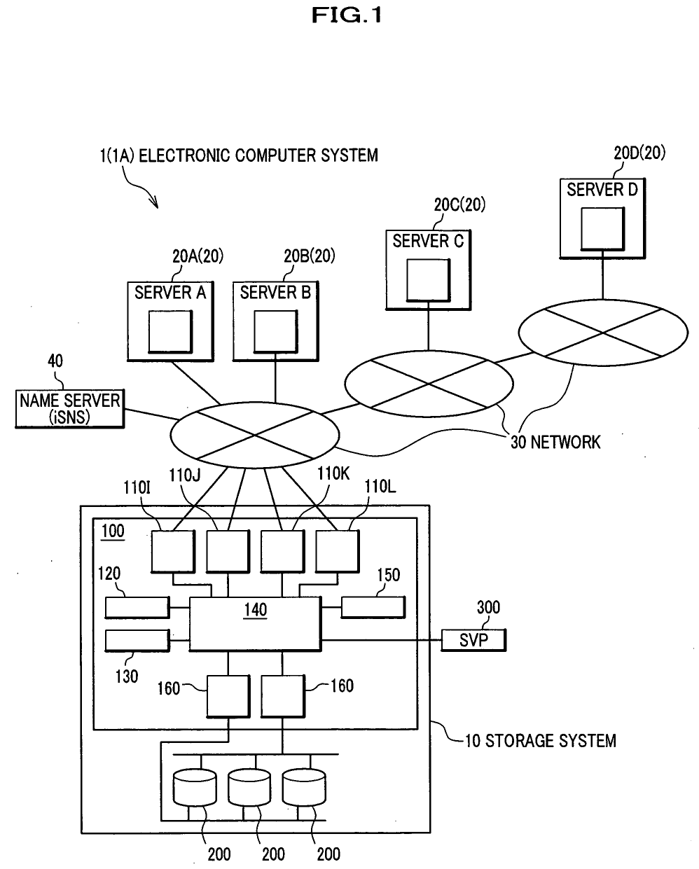

Referring to FIG. 1, an electronic computer system 1 (1A) includes a storage system 10, servers 20 (servers 20A, 20B, 20C and 20D), and a name server 40 which are all connected to a network 30. In this system, packet-formatted data is sent/received between the storage system 10 and the servers 20 through the network 30. The server 20 writes/reads data to or from the storage system 10 by using a write/read command of SCSI that is an upper layer protocol of iSCSI.

The storage system 10 includes a storage controller 100, memory units 200, and a service processor (SVP) 300. Each memory unit 200 is a disk drive device to which data is written by a host.

The storage controller 100 is provided with network ports 110I, 110J, 110K and 110L. Typically, these network ports each have a physical port to be connected to the network 30 through a high speed IP interface such as Gigabit Ethernet (trademark). Furthermore, each network port may have sending and receiving buffers that store send data and receive data temporally, respectively.

The storage controller 100 includes a processor 120, a control memory 130 that stores various pieces of control information, a cash memory 150, and back-end interfaces 160 which are connected to the memory units 200 and which input/output data to or from the memory units 200. Moreover, the storage controller 100 includes a data controller 140 that controls internal data transfer. Note that each of the servers 20, the name server 40, and the SVP 300 is implemented by a computer including a processor, a memory unit, a computer and an input/output device.

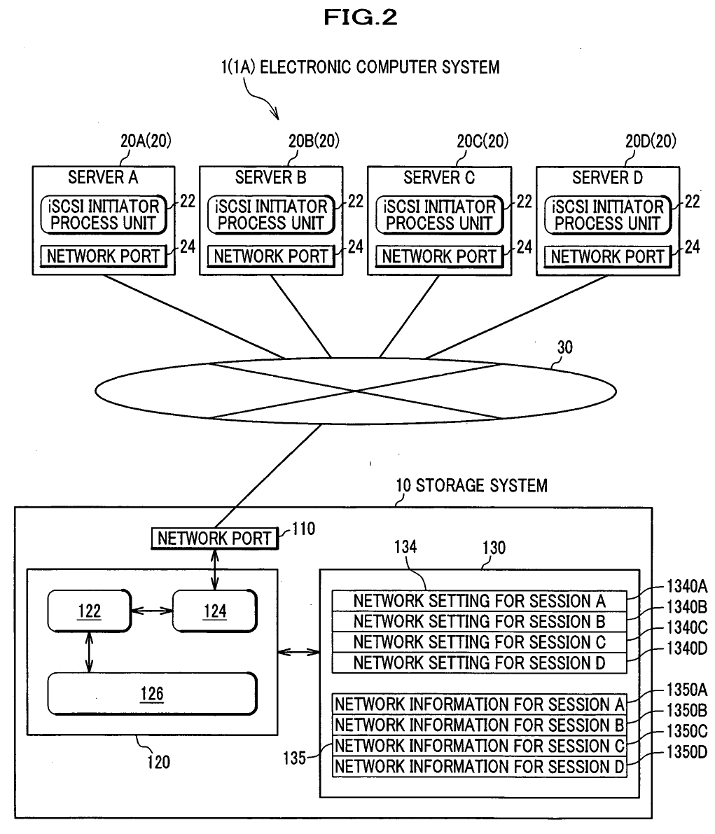

Referring to FIG. 2, each server 20 includes a network port 24, and an iSCSI initiator process unit 22 that serves an iSCSI initiating function with a processor.

The processor 120 of the storage system 10 includes a lower protocol layer controller 122, a communication management unit 124 and an upper protocol layer controller 126. The lower protocol layer controller 122 performs processes according to the protocols of MAC, TCP and IP layers. The upper protocol layer controller 126 carries out processes in compliance with the protocols of ISCSI and SCSI layers. In this case, the communication management unit 124 checks and controls frames which the storage system 10 receives from the network ports 110 via the network 30.

The communication management unit 124 acquires statistical information on each session through the network ports 110. Specifically, this acquisition is periodically executed as a timer interrupt process. Subsequently, the communication management unit 124 allows a session-unit network information table 135 and a session-unit network setting table 134 to reflect on the acquired information. Specifically, the communication management unit 124 measures the network round trip time, the buffer capacity and the packet error rate of a current session, and then, updates information stored in the session-unit network information table 135, based on the measured result. Continuously, the communication management unit 124 determines the contents of the session-unit network setting table 134, based on the updated session-unit network information table 135. Detail description of this manner will be given later.

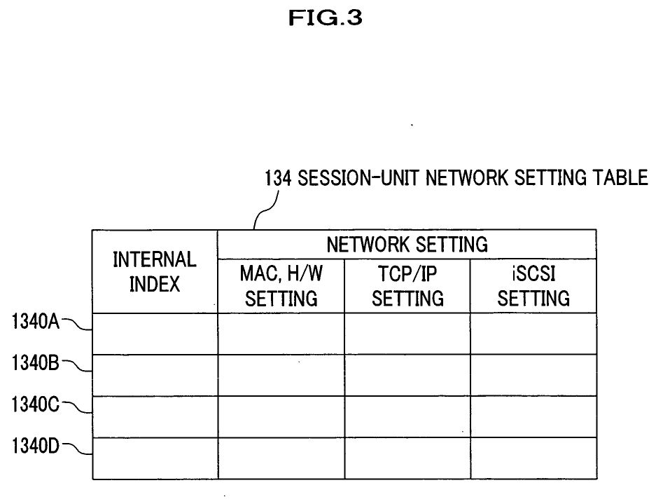

Referring to FIG. 3, the session-unit network setting table 134 contains information on the network setting of each session and internal indexes used for internal process, and is stored in the control memory 130 as shown in FIG. 2. The information on the network setting indicates the setting parameters of each protocol layer or ON/OFF of an optional function. The network setting includes the following three categories:
(1) A maximum transmission unit (MTU) of Ethernet (trademark) or buffer capacity of sending/receiving buffer, defined by the MAC layer;
(2) IP packet length, setting of TCP timeout, or use of optional algorithm, defined by the TCP/IP layer; and
(3) log-in parameters such as an error recovery level, an iSCSI Keep Alive Timer or an iSCSI PDU length, defined by the iSCSI/SCSI layer.

Examples of the optional algorithm include Delayed ACK that averages the return interval of ACK defined by the TCP layer, and Slow Start that averages the sending interval of data. In addition, QoS (quality of service) may be used to guarantee that data is sent at a constant rate.

The above information on network setting is stored in the session-unit network setting table 134 per session, and is updated and managed regularly. Conventionally, the above information is common among the ports of a storage system, or is individually managed in each port. However, in this embodiment, this information is managed such that the network setting can be changed per session. Referring to FIG. 3, four sessions are communicated currently, and are registered in the session-unit network setting table 134 independently of one another. The entries of 1340A, 1340B, 1340C and 1340D correspond to the sessions A, B, C and D, respectively. The contents of this table 134, that is, the network setting of each session may be recorded in a log via the SVP 300 or shown in a form that an administrator can see.

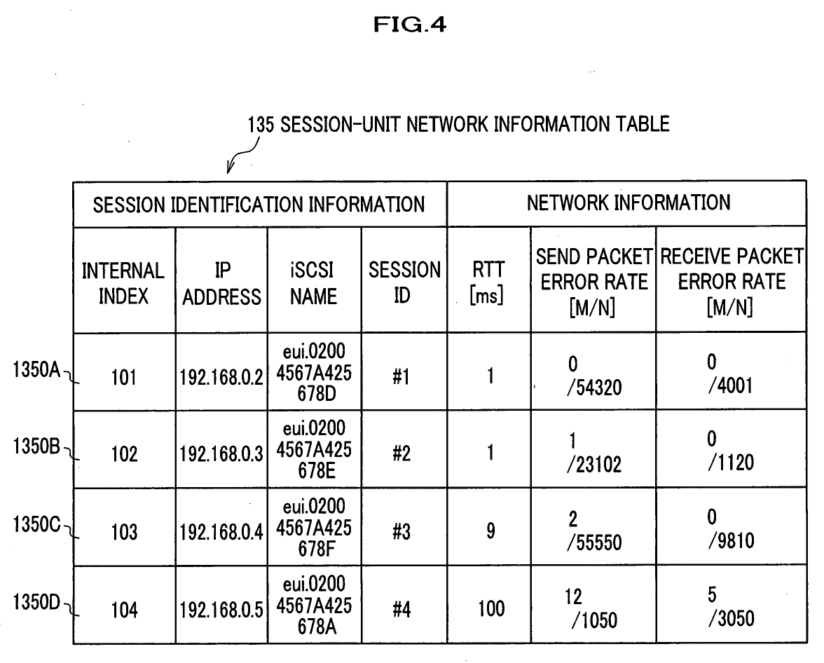

Referring to FIG. 4, the session-unit network information table 135 contains information on communication status of each session on the network. As shown in FIG. 2, the session-unit network information table 135 is stored in the control memory 130. Information is added to this table whenever a new session is generated, and is updated or managed regularly. The session-unit network information table 135 contains session identification information and network information. The session identification information contains an internal index, an IP address, an iSCSI name and a session ID which are all used for internal processing. The network information contains round trip time (RTT) that indicates round trip time of a network, and a packet error rate. This packet error rate further contains a send packet error rate and a receive packet error rate. The send packet error rate is defined as A/B. B is the total number of packets being sent, and A is the number of ACKs which correspond to the packets being sent, and which are not received during a predetermined period. Specifically, the send packet error rate refers to the number of packets deemed to be lost. The receive packet error rate is defined as C/D. C is the number of packets deemed to be error. D is the total number of receive packets. The detail description will be given later.

Referring to FIG. 4, four sessions are communicated, similar to the table of FIG. 3. Information on each session is registered in the session-unit network information table 135. The entries of 1350A, 1350B, 1350C and 1350D correspond to the session A, B, C and D, respectively. If the same index is listed in both the tables 134 and 135, then the same network setting or information is included in them. In addition, the contents of the session-unit network setting table 134, that is, the network communication state of each session may be recorded in log via the SVP 300, or may be shown in the form that an administrator can see.

[Operation of Communication Process]

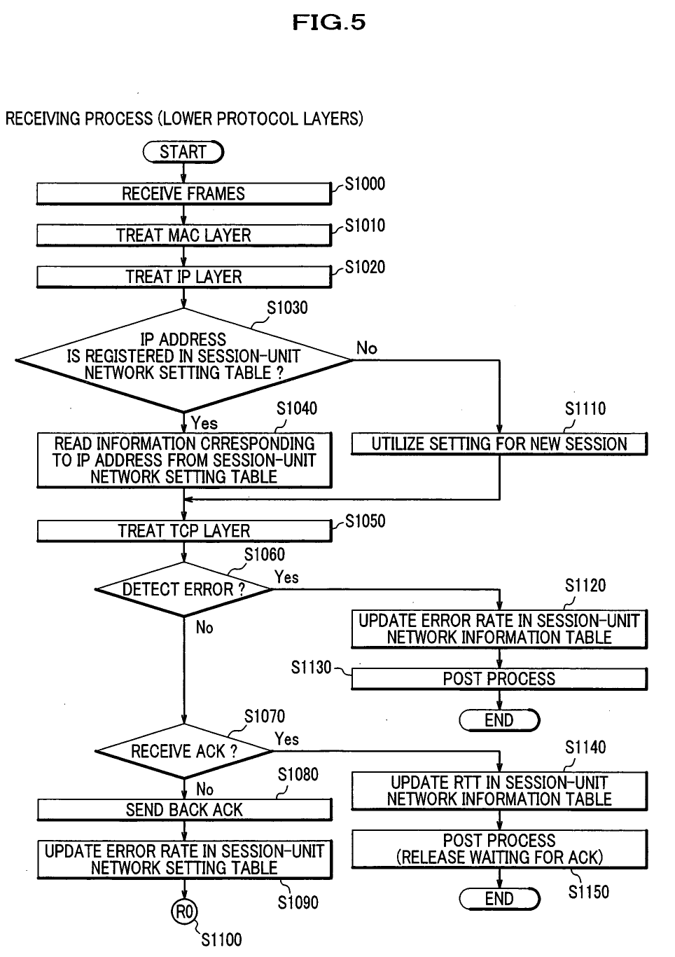

Routines shown in FIGS. 5 through 12 are executed by the lower protocol layer controller 122, the communication management unit 124 and the upper protocol layer controller 126 in the control memory 130.

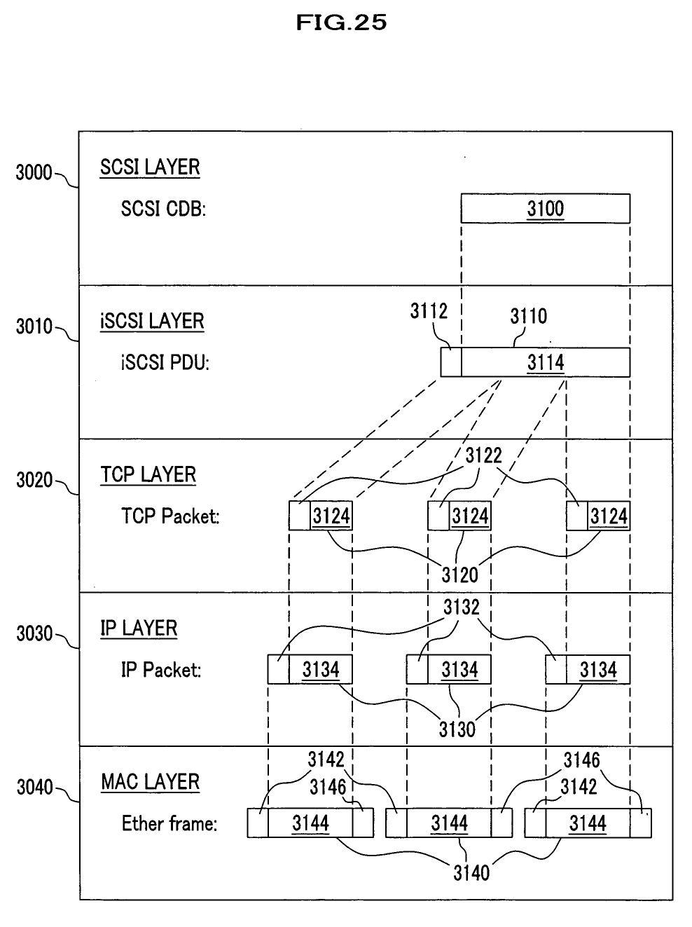

Referring to FIG. 5, the storage system 10 starts a receiving process by receiving a MAC frame 3140 thorough the network 30 (S1000). Next, the lower protocol layer controller 122 performs a MAC layer receiving process (S1010) and an IP layer receiving process (S1020) in this order. The storage system 10 determines whether or not an IP address stored in an IP header (FIG. 25) and indicating a destination is registered already in the network setting table 134 (S1030). If the IP address is registered (“Yes” at S1030), then the storage system 10 reads, from the table 134, the network setting of a session corresponding to the registered IP address (S1040). Then, the storage system 10 makes it reflect on the process of each protocol layer, and renders a next step proceeds to S1050. Otherwise, the IP address is not registered (“No” at S1030), then predetermined network setting for defining a new session is applied to the process of each protocol layer (S1110). A next step is made to proceed to S1050. The network setting for defining a new session is defined such that the time out of the TCP layer and of the SCSI layer have relatively long values, and the protocol option of each protocol layer has a minimum value. This network setting allows the storage system 10 to operate even on the network of bad conditions, such as long RTT or high packet error rate.

At step S1050, a TCP layer receiving process is performed. Subsequently, the storage system 10 determines whether any error is detected or not (S1060). If no errors are detected (“No” at S1060), then a next step is made to proceed to S1070. Otherwise, if any error is detected and, thus the receiving process cannot continue anymore (“Yes” at S1060), then a next step is made to proceed to S1120. Next, an error rate in the session-unit network information table 135 is updated in accordance with the loss of the received packets (S1120). At S1120, the error rate is updated based on the number of the error packets and the total number of the received packets.

At S1070, the storage system 10 determines whether or not the received frame is ASK corresponding to data which the storage system 10 have sent. If the received frame is the ACK (“Yes” at S1070), then the storage system 10 allows a next step to proceed to S1140, and it updates the session-unit network information table 135. In this case, the RTT of the ACK is stored in the network information setting tale 134 as the RTT of the current session. Next, the storage system 10 stops waiting for ACK (post process) thereby terminating the receiving process.

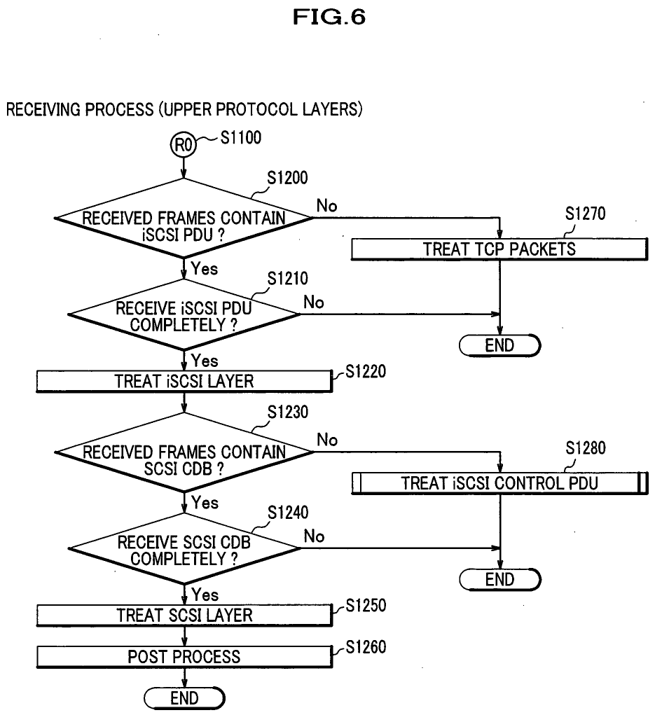

If the received frame is not the ACK (“No” at S1070), then the storage system 10 allows a next step to proceed to S1080, and sends back the ACK to the sending source of the data (S1080). Next, the storage system 10 updates the error rate of the session-unit network information table 135 according to successfully received packets (S1090). At S1090, the error rate is updated by using the total number of the received packets alone. Next, “R0” at S1100 in FIG. 6 is performed.

Referring to FIG. 6, the storage system 10 determines whether or not the received frame contains iSCSI PDU (S1200). If the iSCSI PDU is not contained (“No” S1200), then the storage system 10 allows a next step to proceed to S1270 and, then handles TCP control packet (S1270), thereby terminating the receiving process. Otherwise, if the iSCSI PDU is contained (“Yes” S1200), then the storage system 10 allows a next step to proceed to S1210. Subsequently, the storage system 10 determines whether or not the iSCSI PDU is received completely.

If the iSCSI PDU is not received completely, then the received process is terminated. This is because it can be considered that the iSCSI PDU is to be finished upon reception of subsequent remaining frames. Otherwise, if the iSCSI PDU is received completely (“Yes” at S1210), then the storage system 10 allows a next process to proceed to S1220, and carries out a receiving process of the iSCSI layer. Next, the storage system 10 determines whether or not the iSCSI PDU contains SCSI CDB (S1230).

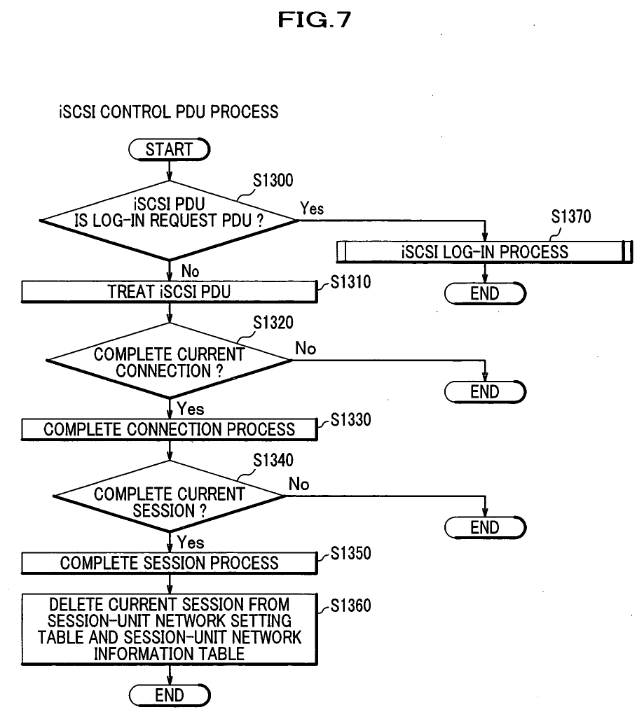

If the SCSI CDB is not contained (“No” at S1230), then the iSCSI PDU receives control PDU of iSCSI, thereby terminating the process. A detail description will be given later, of the process of receiving the control PCU of iSCSI with reference to FIG. 7.

Otherwise, if the SCSI CDB is contained (“Yes” at S1230), then the storage system 10 allows a next step to proceed to S1240, and, then determines whether or not the received SCSI CDB is completed. For example, since write data may be received over multiple frames, whether the write data is completed or not is checked at this step. If the SCSI CDB is not completed (“No” at S1240), then the storage system 10 terminates the receiving process. This is because it can be considered that the SCSI CDB is terminated upon reception of subsequent remaining frames. Otherwise, if the SCSI CDB is completed (“Yes” at S1240), then the storage system 10 allows a next step to proceed to S1250. Next, the storage system 10 executes a SCSI layer receiving process (S1250), and a post process such as releasing a buffer storing SCSI CDB (S1260), so that the receiving process is terminated.

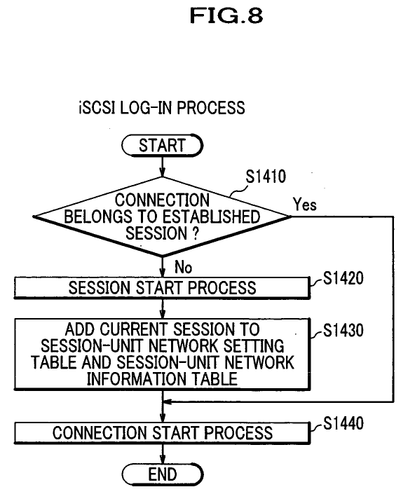

Referring to FIG. 7, the storage system 10 determines whether or not the terminated iSCSI PDU is a log-in request PDU (S1300). If it is the log-in request PDU (“Yes” at S1300), then the storage system 10 executes a log-in process at S1370, so that the process is terminated. The detail will be described later with reference to FIG. 8.

Otherwise, if it is not the log-in request PDU (“No” at S1300), then the storage system 10 allows a current step to proceed to S1310 and, then handles iSCSI PDU (S1310). At S1310, if iSCSI PDU is a log-out request PDU specifically, then a log-out process is done. In this case, the connection through which the iSCSI PDU is sent is terminated.

Next, the storage system 10 determines whether the connection is completed or not (S1320). If it is not terminated (“No” at S1320), then the storage system 10 terminates the receiving process. This is because the connection is deemed to be completed upon receipt of subsequent remaining frames. Otherwise, if the connection is terminated (“Yes” at S1320), the storage system 10 allows a next step to proceed to S1330.

At S1340, the storage system 10 determines whether or not a session including the connection is completed. To determine this, whether or not the session has a single connection is checked. If it has a single connection, the session is completed. Then, if the session is completed (“Yes” at S1340), the storage system 10 makes a next step proceed to S1350 and, then performs a session termination process. Next, the storage system 10 allows a next step to proceed to S1360 and, then deletes the information on the session from the session-unit network information table 135 and the session-unit network setting table 134, so that the receiving process is terminated. Otherwise, if the session is not completed (“No” at S1340), then the storage system 10 terminates the receiving process.

Referring to FIG. 8, at S1410, the storage system 10 determines whether or not the iSCSI PDU is sent through a connection which belongs to the existing (already established) session. If the iSCSI PDU is sent through the connection of the existing session (“Yes” at S1410), then the storage system 10 renders a next step proceed to S1440.

Otherwise, if the ISCSI PDU is not sent through the connection of the existing session (“No” at S1410), then the storage system 10 makes a next step proceed to S1420. Specifically, since the received iSCSI log-in request PDU is an iSCSI log-in request PDU for establishing a first connection of the session, a session start process is carried out at S1420. Then, information on the session is added to the session-unit network setting table 134 and the session-unit network information table 135 at step S1430, and a next step is made to proceed to S1440. At S1440, the connection start process is performed, and then, the receiving process is terminated.

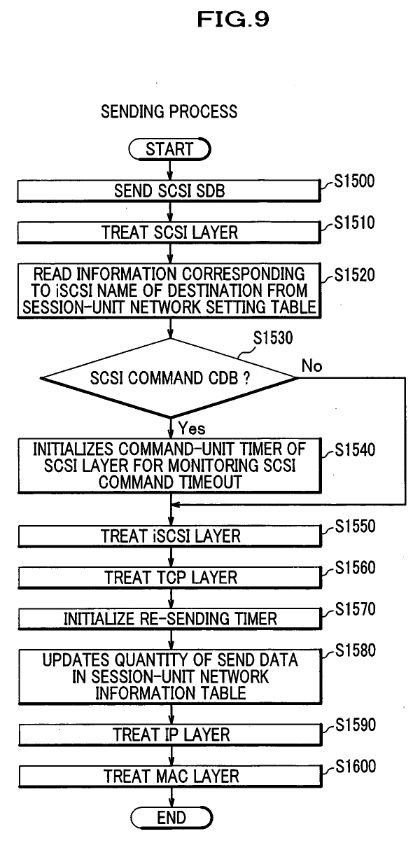

Referring to FIG. 9, the storage system 10 starts a sending process in order to send SCSI CDB 3100 to the server 20 over the network 30 (S1500). First, the storage system 10 carries out a sending process for forming CDB in a SCSI layer (S1510). Second, the storage system 10 reads, from the session-unit network setting table 134, network setting corresponding to an iSCSI Name indicating a destination servers 20 (S1520). The setting being read is applied to a sending process subsequent to S1530.

Next, the storage system 10 determines whether or not SCSI CDB 3100 to be sent is a SCSI command CDB (S1530). If it is a SCSI command CDB (“Yes” at S1530), then the storage system 10 initializes a command-unit timer of a SCSI layer for monitoring SCSI command timeout at S1540 and, then allows a next step to proceed to S1550. Otherwise, if it is not a SCSI command CDB (“No” at S1530), then a next step is made to proceed to S1550.

At S1550, the storage system 10 carries out a sending process of the ISCSI layer. Specifically, the SCSI CDB 3100 is reshaped into an iSCSI PDU 3110. Subsequently, the storage system 10 executes a sending process of the TCP layer (S1560). Specifically, the iSCSI PDU3110 is reshaped into TCP packets 3120.

Furthermore, the storage system 10 initializes a re-sending timer of the TCP layer (S1570) and, then updates information on the quantity of data to be sent in the session-unit network information table 135 (S1580). Specifically, the quantity is increased depending on the number of TCP packets to be sent. Next, the storage system 10 performs a sending process of the IP layer (S1590). Concretely, the TCP packets 3120 are reshaped into IP packets 3130 so as to be adapted in the IP layer. Next, the storage system 10 carries out a sending process of the MAC layer (S1600). Specifically, IP packets 3130 are reshaped into MAC frames 3140, and they are then sent over the network 30, thereby terminating the sending process.

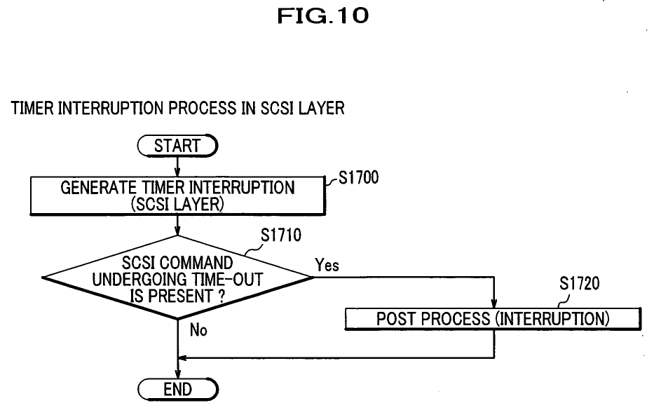

Referring to FIG. 10, the storage system 10 executes a timer interrupt process at predetermined intervals (S1700). In the timer interrupt process, the storage system 10 determines whether or not any SCSI command CDB undergoing time-out is present in the SCSI command CDB (S1710). If the SCSI command CDB undergoing timeout is not present (“No” at S1710), then the storage system 10 terminates the timer interrupt process. Otherwise, if the SCSI command CDB undergoing timeout is present (“Yes” at S1710), then the storage system 10 performs a process in which the SCSI command CDB is interrupted (post process) (S1720). Concretely, this SCSI command CDB is eliminated from a target of CDB timeout monitor, so that the timer interrupt process is terminated.

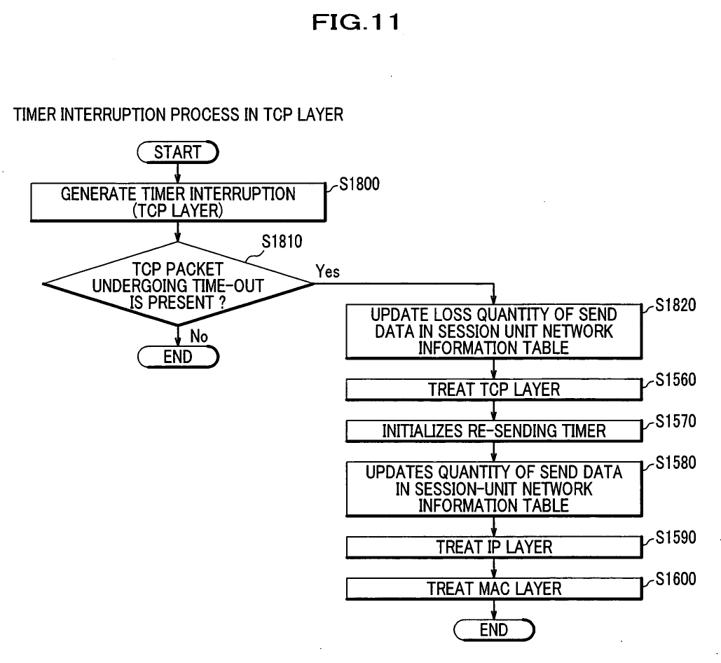

Referring to FIG. 11, the storage system 10 starts a process by causing timer interrupt of the TCP layer at regular intervals (S1800). In the timer interrupt process of the TCP layer, the storage system 10 determines whether or not there is any TCP packet undergoing timeout from among TCP packets which have been sent and of which corresponding ASK responses are not received (S1810). If the TCP packet undergoing time-out is not present (“No” at S1810), the storage system 10 terminates the timer interrupt process. Otherwise, if the TCP packet is present (“Yes” at S1810), the loss quantity of the data being sent in the session-unit network setting table 134 is updated (S1820). Thereafter, to re-send the TCP packet, the process subsequent to the TCP layer sending process at S1560 is performed. However, since this process is similar to the sending process of FIG. 9, a description will be omitted by applying the same reference numerals to the same portions.

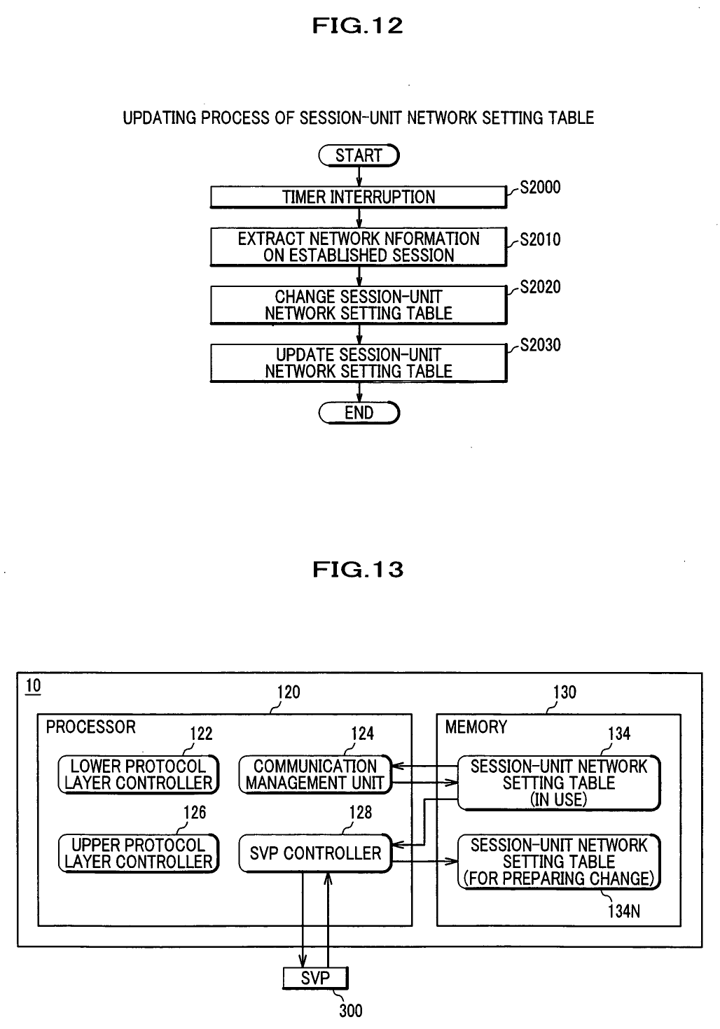

Referring to FIG. 12, the storage system 10 generates timer interruption at regular intervals (S2000), and updates the session-unit network information table 135. The storage system 10 extracts the network information on a session from the session-unit network information table 135 (S2010). Then, it changes network setting of the session, based on the extracted network information.

Specifically, if the packet error rate of the session is equal to/more than a predetermined value al, or if the RTT is equal to/more than a predetermined value βF2,
(1) the allocated capacity of the sending buffer in the session is increased,
(2) the SCSI timeout and TCP timeout values in the session are increased, and
(3) a protocol option of the TCP layer is applied to the session.

Otherwise, if the packet error rate of the session falls below the predetermined value α1, or if the RTT falls below the predetermined value β2,
(1) the allocated capacity of the sending buffer in the session is decreased,
(2) the SCSI timeout and TCP timeout values are decreased, and
(3) a protocol option of the TCP layer is not applied to the session.

Note that the values of α1 and β2 depend on the required performance of the network system, and they are determined by an administrator prior to an actual use.

Thereafter, the storage system 10 allows the network setting of the session-unit network information table 135, which has been defined at S2020, to reflect on the session-unit network setting table 134, thereby terminating the interrupt process.

Referring to FIG. 13, the communication management unit 124 reads information from the session-unit network setting table 134 as needed and, then transfers the network setting of the session to the lower and upper protocol layer controllers 122 and 126. The communication management unit 124 changes the contents of the session-unit network setting table 134 and the session-unit network information table 135 in this order, but an administrator may change this order. Specifically, an administrator prepares a session-unit network setting table 134N for change preparation, independently of the session-unit network setting table 134. Furthermore, the administrator inputs information on setting information into the session-unit network setting table 134N through the SVP 300. Next, in response to instruction that the information is inputted, the information in the session-unit network setting table 134N is copied to the session-unit network setting table 134. This is how the setting information can be changed for a short time. The communication with the SVP 300 is established by a SVP controller 128 operating in the processor 120.

As described above, the IP storage of the first embodiment is provided, which extracts information on the network per session, and sets up the network optimally, based on the extracted information. Therefore, this IP storage is less likely to be affected by network conditions even when being connected to networks of different specifications such as communication distance or performance, thereby achieving stable communication performance.

### Second Embodiment

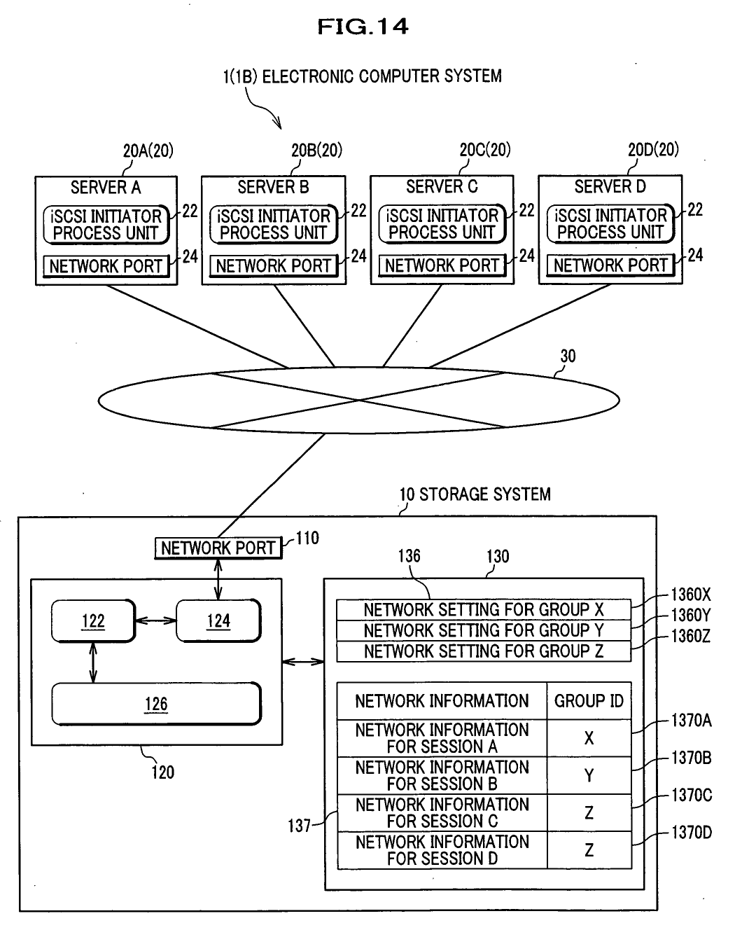

Referring to FIG. 14, a system of this embodiment fundamentally has a similar configuration to that of the first embodiment. The system of this embodiment includes a group-unit network setting table 136 and a session-unit network information table 137 in a control memory 130. Since other components are similar to those of the first embodiment, a description thereof will be omitted.

[System Configuration]

The system of the first embodiment controls network setting per session. In contrast, this system forms some groups in advance each of which is composed of sessions, and handles the group as a unit of network setting. Therefore, the same network setting is applied to the sessions in one group, and the network settings of sessions in different groups differ from one another. A detail description thereof will be given later.

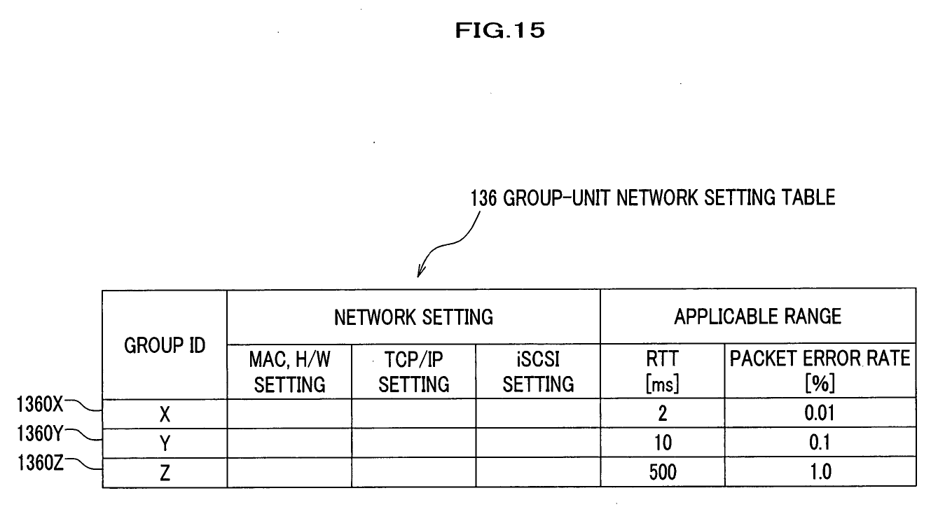

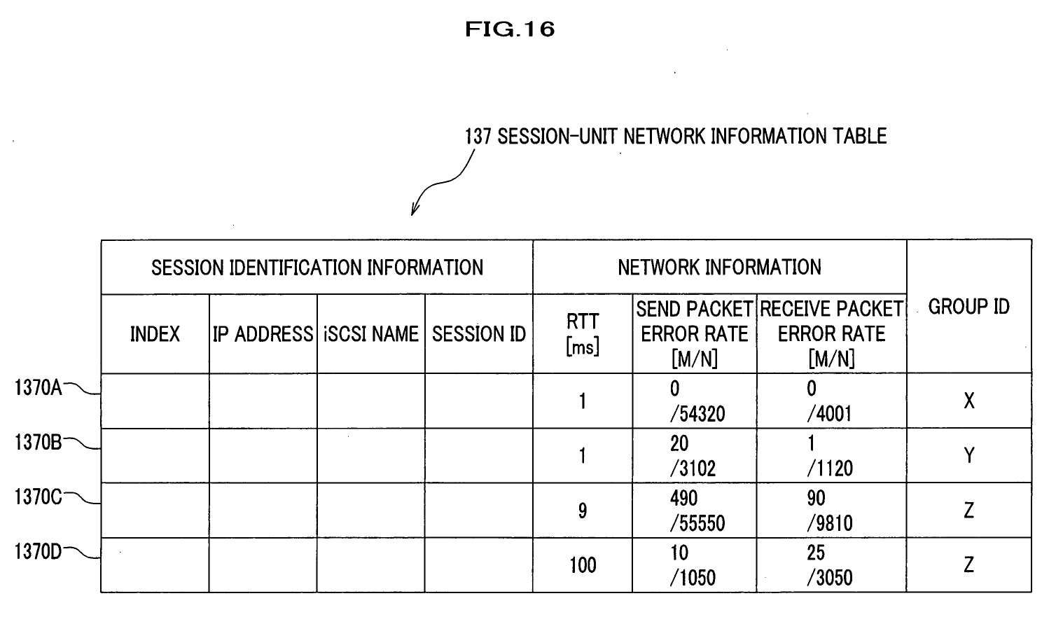

To group the sessions, an administrator defines beforehand, by using a SVP, the ranges of the RTT and error occurrence rate which are allowed by each group. Concretely, the storage system 10 monitors the RTT and error occurrence rate (packet loss rate) of each session at regular intervals, and determines how to group the sessions. In this process, the group-unit network setting table 136 shown in FIG. 15 and the session-unit network information table 137 shown in FIG. 16 are used. These tables are included in a control memory 130.

Referring to FIG. 15, the group-unit network setting table 136 is similar to the session-unit network setting table 134 of the first embodiment in that it contains network setting and an internal index of each group which are used for an internal process. However, the group-unit network setting table 136 further contains the range of network status which is allowed by each group. This information is set in advance by an administrator through the SVP. In FIG. 15, groups X, Y and Z are set, and are stored in group-unit network setting table 136, as 1360X, 1360Y and 1360Z, respectively.

In an applicable range of FIG. 15, the group X allows a RTT range of equal to/less than 2 ms and a packet error rate range of equal to/less than 0.01%, the group Y permits a RTT range of equal to/less than 10 ms and a packet error rate range of equal to/less than 0.1%, and the group Z allows a RTT range of equal to/less than 500 ms and a packet error rate range of equal to/less than 1.0%. Note that this applicable range can be expanded or narrowed depending on the network status.

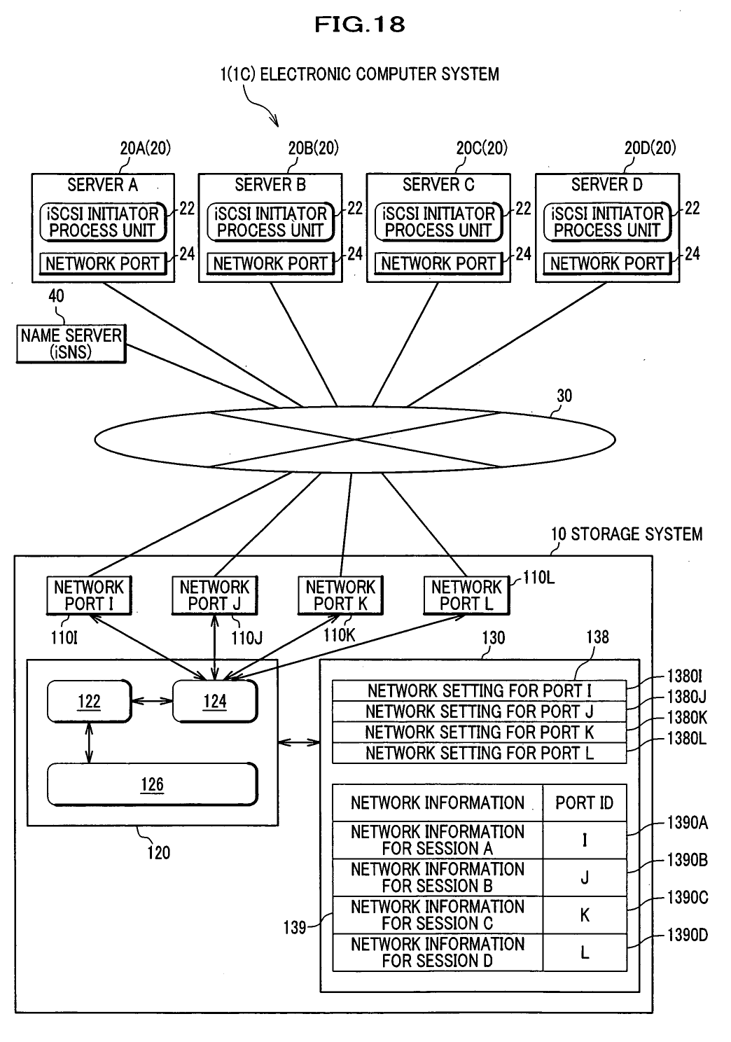

Referring to FIG. 16, session-unit network information table 137 contains RTT and error occurrence rate (packet loss rate) of each session, and a group ID indicating groups which the sessions belong to. In this embodiment, the groups ID of the groups X, Y and Z correspond to X, Y and Z of FIG. 18, respectively. Entries 1370A, 1370B, 1370C and 1370D of the session-unit network information table 137 contain the network information on the sessions A, B, C and D in this order. The sessions A, B, C and D belong to the groups X, Y, Z and Z, respectively.

[Operation of Communication Process]

Sending and receiving processes of the storage system 10 of this embodiment are similar to those of the first embodiment. Hence, a description of similar portions will be omitted.

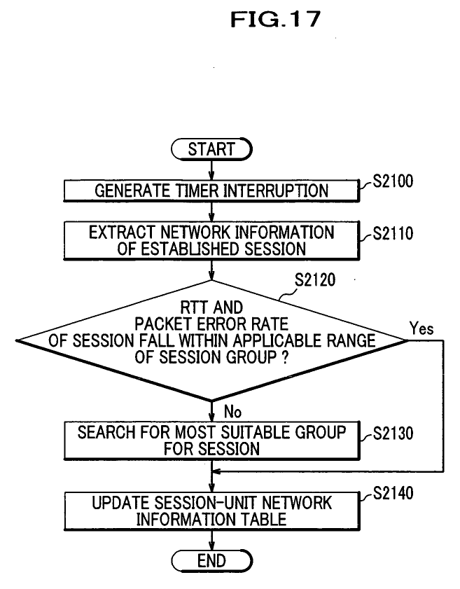

Referring to FIG. 17, the storage system 10 updates the session-unit network setting table 137 by generating interruptions at regular intervals (S2100). Next, the storage system 10 extracts information on the network of each session from the session-unit network information table 137 (S2110). Furthermore, the storage system 10 determines whether or not the RTT and packet error rate of a current session fall within an applicable range of a group which the session belongs to (S2120). If it falls within the applicable range (“Yes” at S2120), then the storage system 10 terminates the interrupt process.

Otherwise, it falls outside the applicable range (“No” at S2120), then the storage system 10 search for a most suitable group for the current session (S2130) and, then updates the contents of the session-unit network information table 137 (S2140), so that the interrupt process is terminated.

As described above, the IP storage of the second embodiment is provided, which extracts information on the network per session, and sets up the network optimally, based on the extracted information. Therefore, this IP storage is less likely to be affected by network conditions even when being connected to networks of different specifications such as communication distance or performance, thereby achieving stable communication performance.

### Third Embodiment

A storage system 10 of a third embodiment has multiple ports and utilizes a function of an iSCSI name server. However, since other components and communication processes are similar to those of the first embodiment, a description of similar portions will be omitted.

[System Configuration]

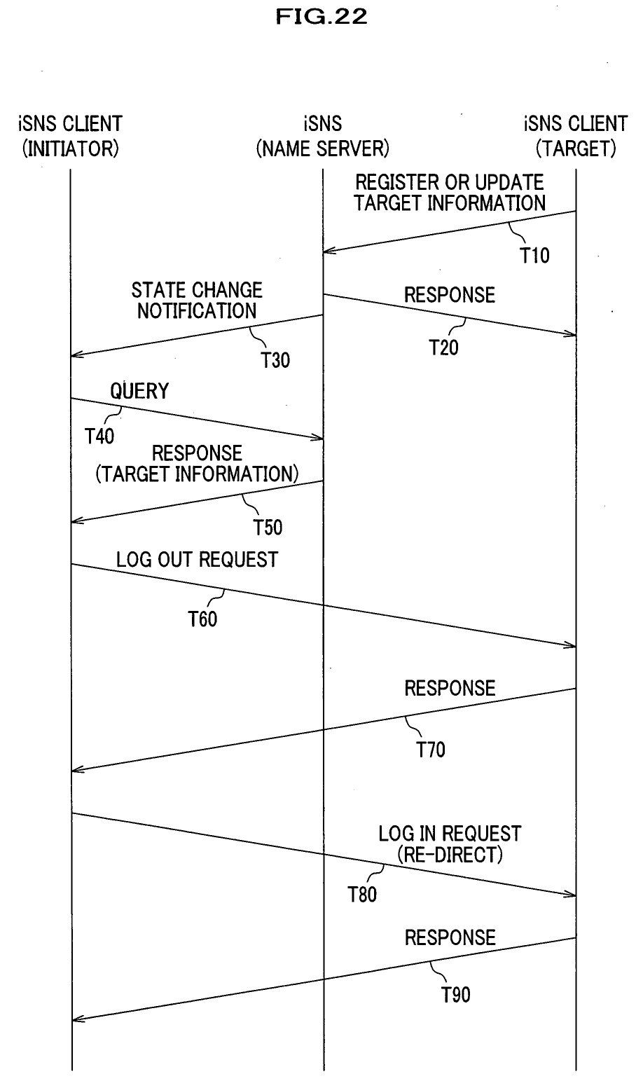

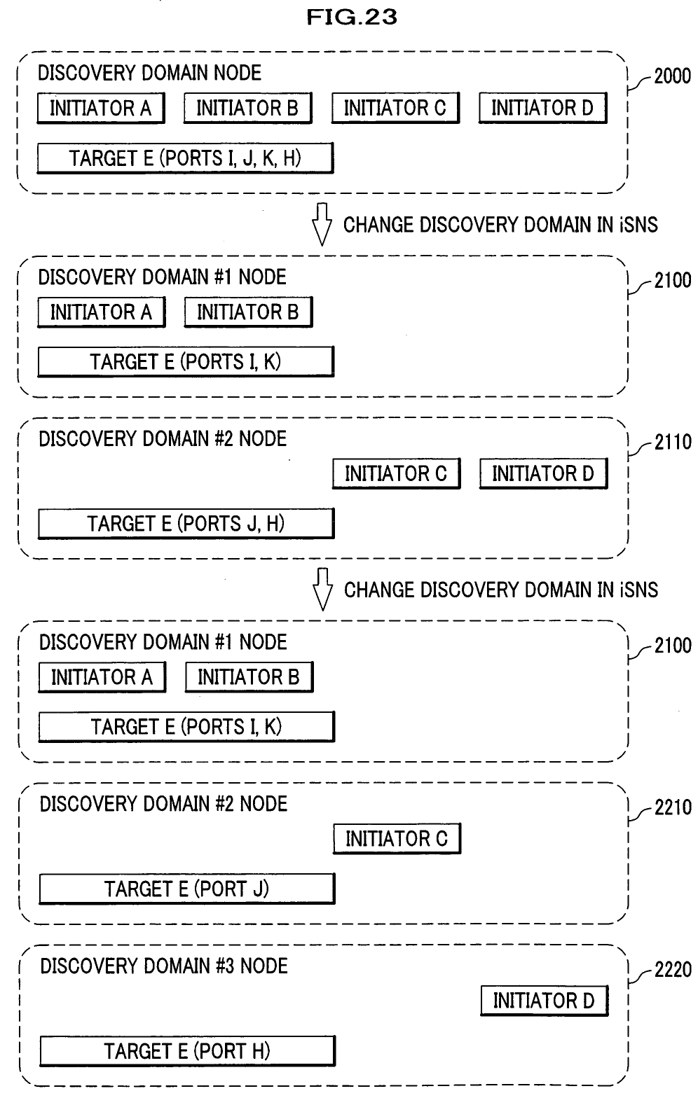

A typical storage system has multiple physical ports, and in this embodiment, network parameters are allocated to such ports. All the ports can log in to the same iSCSI target. Once a session is established, the storage system 10 monitors the RTT and the packet error rate of this session, and re-directs a connection to a physical port suitable for the session. The above monitor and re-direction are performed by a communication management unit 124. This re-direction is executed with an iSCSI name server function of an ISNS name server 40. A detail description thereof will be given later with reference to FIGS. 22 and 23.

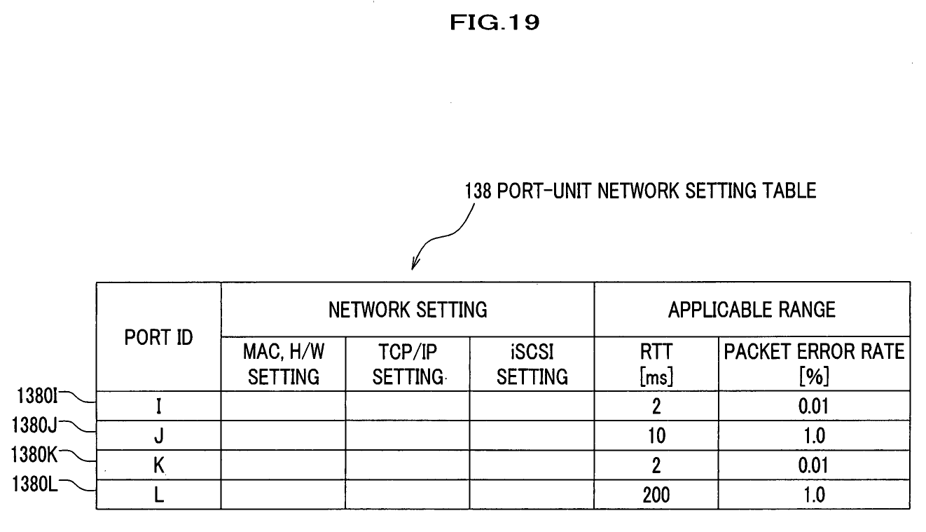

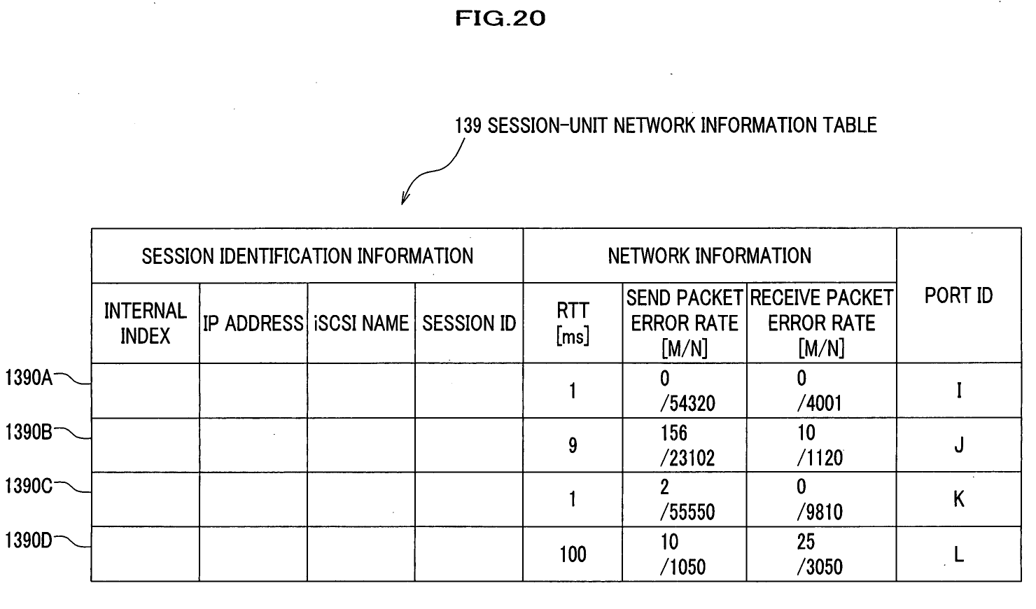

The re-direction is controlled based on the port-unit network setting table 138 shown in FIG. 19 and the session-unit network information table 139 shown in FIG. 20. The storage system 10 of the second embodiment defines the same network sessions per group. In contrast, the storage system 10 of the third embodiment defines network setting per physical port. However, since other features are similar to that of the first or second embodiment, a description thereof will be omitted.

[Operation of Communication Process]

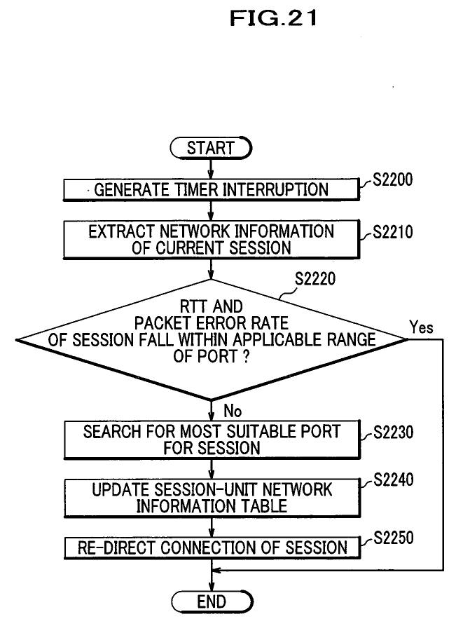

Referring to FIG. 21, the storage system 10 updates the session-unit network setting table 138 by generating interruptions at regular intervals (S2200). Subsequently, the storage system 10 extracts information on network of each session from the session-unit network information table 139 (S2210). Furthermore, the storage system 10 determines whether or not the RTT and packet error rate of this session fall within an allowable range of a port which the session belongs to, based on the extracted information (S2220). If they fall within the allowable range, the storage system 10 terminates this interrupt process.

Otherwise, if they fall outside the allowable range (“No” at S2220), the storage system 10 searches for a port suitable for the current session (S2230) and, then updates the contents of the session-unit network information table 139 (S2240). Finally, the storage system 10 re-directs a connection to the searched port (S2250), thereby terminating the interrupt process.

Referring to FIG. 22, a name server 40 utilizes a name server function called “internet storage naming service (iSNS)” defined by iSCSI. The name server (iSNS) serves as a client-server, and both an iSCSI initiator and a target serve as iSNS clients. The iSNS name server 40 stores information about apparatuses on IP-SAN into its database (not shown), and applies a naming service for querying about the information of the database in response to request from the iSNS client.

In IP-SAN, the iSNS receives target information T10 from an iSCSI target, and sends back a response T20 thereto, as well as registers a relation between an IP address and an iSCSI name of the iSCI target to the database. If the target information registered in the database is changed, the iSNS sends a state change notification (SCN) T30 to the iSNS clients located in an area to be affected by the change, that is, the iSNS clients located in discovery domains. Upon reception of the SCN T30, the iSNS client queries the iSNS how the target information has been changed, and acquires a response T50 that is updated target information. Up to this point, the basic operation of the iSNS name server has been described.

The discovery domain (DD) is defined as a set of iSCSI nodes (initiator and target). Although being omitted in FIG. 21, the DD is registered manually by an administrator through a controller registered in the iSNS beforehand. The ISCSI initiator acquires information on available iSCSI targets by utilizing a function called “discovery” in iSCSI. Furthermore, the iSCSI initiator issues a discovery request, and the iSNS responds only information on targets defined by the DD, so that only information on the targets that can be accessed by the iSCSI initiator is informed.

In this embodiment, (1) the initiator acquires a response T50 containing target information, (2) the initiator sends a log-out command T60 to the target, (3) the target sends back, to the initiator, a response T70 indicating that the log-out is completed in response to the command T60, (4) the initiator sends a log-in command to another target, and (5) the target sends back, to the initiator, a response T90 indicating that log-in is completed. Consequently, re-direct process is succeeded. Using this re-direct process makes it possible to set up the network appropriately.

Referring to FIG. 23, as soon as the storage system 10 is activated, only a DD (shown by 2000) is registered. In the circumstances, the storage system 10 starts a communication with the hosts A to D (the servers 20A to 20D in FIG. 18). In this case, it is assumed that the respective communications with the initiators A and B have relatively short RTT and low packet error rate. Note that the former communication corresponds to the session A, and the latter corresponds to the session B. On the other hand, the respective communications between the initiators C and D have relatively long RTT and high packet error rate. In this case, the former communication corresponds to the session C, and the latter corresponds to the session D.

Next, the contents of the DD are changed to be defined as DD#1 (shown by 2100) and DD#2 (shown by 2110). This is how ports J and H are set to be adapted for the long RTT and high error rate.

In this case, the way how the network setting is changed is as follow:
(1) the capacity of the buffers allocated to the corresponding sessions is increased;
(2) the length of packets handled at the same time in each protocol layer is shortened; and
(3) option algorithms for increasing overhead in the protocol process is turned on, thereby reducing error rate.

Changing the network setting per port allows the storage system to be adapted for various network environments.

In the circumstances, the sessions A and B communicate with a target E via a port I or K, and the sessions C and D communicate with a target E via a port J or H.

Further, the DD#2 (shown by 2110) where a communication having long RTT and high error rate is conducted is split, and is allocated to DD#2 and DD#3 (shown by 2210 and 2220, respectively). As a result, the communication can be done through a port adapted for a session having various statuses such as level of RTT or of a packet error rate.

In this embodiment, the network setting is controlled per physical port, and the connection is re-directed to the port. However, alternatively the network setting is controlled per logic port such as a TCP port, and the connection may be re-directed to the logical port.

As described above, the IP storage of the third embodiment is provided, which extracts information on the network per session, and sets up the network optimally, based on the extracted information. Therefore, this IP storage is less likely to be affected by network conditions even when being connected to networks of different specifications such as communication distance or performance, thereby achieving stable communication performance.

### Fourth Embodiment

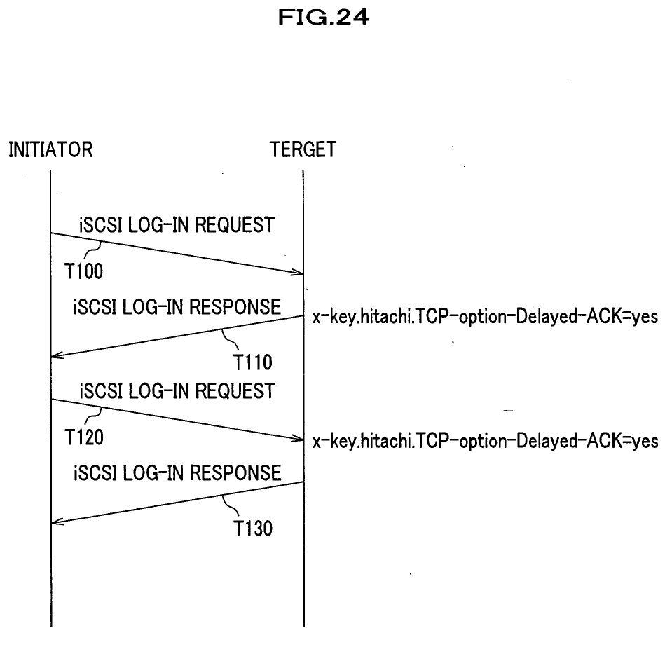

Referring to FIG. 24, negotiation is conducted upon log-in. Except this feature, the configuration and communication process of the system of the fourth embodiment are similar to those of the first embodiment. Alternatively, they may be similar to those of the second or third embodiment. In the first embodiment, predetermined network setting is employed when a new session is applied, as described at the step S1110 of FIG. 5. In contrast, the storage system 10 of this embodiment negotiates with a communication partner to change network parameters defined by layers other than the iSCSI layer. Subsequently, the storage system 10 stores these parameters into the session-unit network setting table 134, instead of using default values.

As an example of a parameter changed by the negotiation, a frame size or buffer capacity in the MAC layer or H/W is cited. As another example of the parameter, an IP packet size, optional algorithm or timeout value in the TCP/IP layer is cited. As an additional example, a log-in parameter, such as a timeout value or an error recovery level, or Keep Alive Timer value in iSCSI or SCSI layer which is an upper layer is cited. However, it is preferable that the parameters in the lower protocol layers are changed by the negotiation.

In iSCSI, parameters except ones defined by the iSCSI layer can be exchanged between the initiator and the target by utilizing a scheme called “Text Command”. In addition, the negotiation for acquiring these parameters can be conducted upon log-in. In FIG. 24, the negotiation of ON/OFF of Delayed ACK, which is one of TCP options, is exemplified.

First, an initiator sends an iSCSI log-in request T100 to a target. Upon reception of this request, the target sends back, to the initiator, an iSCSI log-in response T110 indicating “x-key hitachi. TCP-option-Delayed-ACK=yes”, thereby notifying options that can be defined by the negotiation to the initiator. Next, the initiator sends, to the target, a log-in request T120 indicating “x-key. hitachi. TCP-option-Delayed-ACK=yes”, thereby requesting the use of these options. In response to this request, the target sends back an iSCSI log-in response T130.

In the fourth embodiment, the negotiation can be conducted not only in the iSCSI or SCSI layer but also in another lower layer. Accordingly, it is possible to provide an IP storage in which sessions are resistant to network conditions by changing network setting appropriately, so that stable communications can be realized.

[Modification]

In the above embodiments of the present invention, various modifications can be conceived. For example, the connection means between devices constituting the electronic computer system 1 is not limited to iSCSI. Specifically, the user datagram protocol (UDP) may be employed as an upper protocol of IP, instead of the TCP layer. Moreover, the network file system (NFS) or common internet file system (CIFS) may be employed, instead of the iSCSI or SCSI layer. The method and device of the present invention can effectively be applied to a layered protocol process and a network sensitive to delay or loss of data, respectively. In addition, the topology of the first embodiment is not limited to SAN, but may be various other topologies.

The name server 40 of the third embodiment is an independent device, but it may be incorporated in the server or storage system.

The storage system 10 may be provided with the two storage controllers 100 or the two cash memories 150 in order to allow for a failure of H/W.

Each memory unit is not limited to a hard disk, but it may be a semiconductor memory, magnetic tape, optical disc or combination thereof.

In the above embodiments, the network information and network setting are contained in tables of the control memory, but they may be contained in a list configuration using a pointer.

In the above embodiments, the network information and network setting are controlled per session or per group composed of multiple sessions, but they may be controlled per connection. In this case, since a session is formed by one or more connections, each table in control use is bigger than that of each embodiment, but network setting can be established so as to be more suitable for network paths.

In the above embodiments, the protocol process is implemented by S/W, but it may be implemented by H/W instead. In this case, controller LSI, such as the TCP off-road engine or the iSCSI protocol engine chip, is necessary.

In the above embodiments, the storage system has a function of an iSCSI target, but it may have a function of an iSCSI initiator. However, even when the storage system has a function of an iSCSI initiator or of both an initiator and a target, the control manner per session is similar to those of the above embodiments.

Moreover, the contents of the network setting table and network information table may not be managed regularly. Alternatively, they may be managed every time the storage system receives packets by predetermined times.

In the above embodiments, the network information includes RTT and a packet error rate (loss rate) of data sent from the storage system 10. However, this information may include packet achievability rate instead of the packet error rate. The packet achievability rate is defined by the ratio of the number of packets sent/received successfully to the total number of packets.

An alternative method by which the storage system extracts network information may include the steps of:
(1) sending at regular intervals, to a communication partner, a ping of the TCP layer or an ECHO command that is a presence monitor function of the iSCSI layer,
(2) measuring time period lasted from sending of the ping or command to receiving of a response, and
(3) determining the RTT of the session on the network, based on the measured time.

Furthermore, the control methods of the above embodiments may be executed by running a program on a computer, and this program may be stored in computer readable medium and be read therefrom.

From the aforementioned explanation, those skilled in the art ascertain the essential characteristics of the present invention and can make the various modifications and variations to the present invention to adapt it to various usages and conditions without departing from the spirit and scope of the claims.

What is claimed is;:

1. A communication control method executed by a storage system which includes a processing unit, a storage unit and a connecting unit for a network, the method comprising:
(a) receiving a request for a communication from the network by the connecting unit;
(b) determining at least one characteristic of the communication by the processing unit;
(c) storing the determined characteristic and a threshold of the characteristic in the storage unit;
(d) conducting an analysis of the characteristic by the processing unit, while referring to the threshold;
(e) specifying at least one parameter of a communication protocol based on a result of the analysis by the processing unit; and
(f) performing the communication in accordance with the specified parameter by the connecting unit.

2. The communication control method according to claim 1, wherein the characteristic comprises RTT and an error rate.

3. The communication control method according to claim 2, wherein the parameter is specified per session in (e).

4. The communication control method according to claim 2,
wherein sessions are classed into a plurality of groups, and the parameter is specified per group in (e).

5. The communication control method according to claim 2,
wherein sessions are allocated into a plurality of ports, and the parameter is specified per port in (e).

6. The communication control method according to claim 2,
wherein the communication protocol comprises iSCSI.

7. The communication control method according to claim 6,
wherein sessions are allocated to suitable ports in accordance with ISCSI when the parameter is improper.

8. The communication control method according to claim 6,
wherein the connecting unit negotiates for at least one parameter of iSCSI and at least one parameter of a lower protocol layer upon log-in of the network in accordance with iSCSI.

9. The communication control method according to claim 8,
wherein sessions are allocated into a plurality of ports, and the parameter is specified per port in (e), and
wherein the sessions are allocated to the suitable ports in accordance with iSCSI in (e), when the parameter is improper.

10. A storage system including a processing unit, a storage unit and a connecting unit for a network, the storage system comprising functions of:
receiving a request for a communication from the network by the connecting unit;
determining at least one characteristic of the communication by the processing unit;
storing the determined characteristic and a threshold of the characteristic in the storage unit;
conducting an analysis of the characteristic by the processing unit, while referring to the threshold;
specifying at least one parameter of a communication protocol based on a result of the analysis by the processing unit; and
performing the communication in accordance with the specified parameter by the connecting unit.

11. The storage system according to claim 10,
wherein the characteristic comprises RTT and an error rate.

12. The storage system according to claim 11,
wherein the processing unit specifies the parameter per session.

13. The storage system according to claim 11,
wherein the processing unit classes sessions into a plurality of groups, and specifies the parameter per group.

14. The storage system according to claim 11,
wherein the processing unit allocates sessions into a plurality of ports, and specifies the parameter per port.

15. The storage system according to claim 11,
wherein the communication protocol comprises iSCSI.

16. The storage system according to claim 15,
wherein the connecting unit allocates sessions to suitable ports in accordance with ISCSI when the parameter is improper.

17. The storage system according to claim 15,
wherein the connecting unit negotiates for at least one parameter defined by iSCSI and at least one parameter of a lower protocol layer upon log-in of the network in accordance with iSCSI.

18. The storage system according to claim 17,
wherein the processing unit allocates sessions into a plurality of ports, and specifies the parameter per port, and
wherein the connecting unit allocates sessions to the suitable ports in accordance with iSCSI when the parameter is improper.

19. A storage medium storing a communication control program to be run by a storage system that includes a processing unit, a storage unit and a connecting unit for a network, the communication control program executing a method comprising:
(a) receiving a request for a communication from the network by the connecting unit;
(b) determining at least one characteristic of the communication by the processing unit;
(c) storing the determined characteristic and a threshold of the characteristic in the storage unit;
(d) conducting an analysis of the characteristic by the processing unit, while referring to the threshold;
(e) specifying at least one parameter of a communication protocol based on a result of the analysis by the processing unit; and
(f) performing the communication in accordance with the specified parameter by the connecting unit.

20. The storage medium according to claim 19,
wherein the characteristic comprises RTT and an error rate.
